(19) United States
(12) Patent Application Publication
(10) Pub. No.: US 2016/0031168 A1
(43) Pub. Date: Feb. 4, 2016

(54) Method and Device for Handling a Fiber Arrangement Via Near-Field Levitation

(71) Applicant: Bayerische Motoren Werke Aktiengesellschaft, Muenchen (DE)

(72) Inventor: Gerhard KLEINPETER, Tiefenbach (DE)

(21) Appl. No.: 14/881,215

(22) Filed: Oct. 13, 2015

Related U.S. Application Data
(63) Continuation of application No. PCT/EP2014/065089, filed on Jul. 15, 2014.

(30) Foreign Application Priority Data
Aug. 7, 2013 (DE) 10 2013 215 504.2

(51) Int. Cl. B29C 70/54; B29C 31/08; B29C 70/30

(52) U.S. Cl. CPC B29C 70/54; B29C 70/30; B29C 31/08

(57) ABSTRACT

A method is provided for handling a fiber arrangement to be supplied to a pressing tool. The fiber arrangement is interspersed with a curable matrix material at least in some sections before being supplied to the pressing tool and then is supplied to the pressing tool. The method is characterized in that the fiber arrangement is supplied to the pressing tool largely without contact by acoustic levitation after being interspersed with the matrix material.

### CROSS REFERENCE TO RELATED APPLICATIONS

This application is a continuation of PCT International Application No. PCT/EP2014/065089, filed Jul. 15, 2014, which claims priority under 35 U.S.C. §119 from German Patent Application No. 10 2013 215 504.2, filed Aug. 7, 2013, the entire disclosures of which are herein expressly incorporated by reference.

### BACKGROUND AND SUMMARY OF THE INVENTION

The invention relates to a method for handling a fiber arrangement to be supplied to a pressing tool, wherein the fiber arrangement is interspersed with a curable matrix material at least in some sections before being supplied to the pressing tool and then is supplied to the pressing tool.

The invention further relates to a device for handling a fiber arrangement to be supplied to a pressing tool, having a handling apparatus for supplying the fiber arrangement which has been interspersed with a curable matrix material to the pressing tool.

The invention further relates to use of a device for handling a fiber arrangement to be supplied to a pressing tool.

The manufacture of components, in particular motor vehicle components, through the pressing of a fiber arrangement which has been interspersed with a curable matrix material is known. Since the fiber arrangement interspersed with a matrix material can be wet, the pressing of such a fiber arrangement by way of a pressing tool is also referred to as wet pressing. A matrix material usually comprises a mixture of a resin, a curing agent and a release agent. A fiber arrangement may be designed, for example, as a fiber fabric, nonwoven fabric, fiber cloth, fiber woven fabric, or the like, and may be preimpregnated with a curable matrix material.

For interspersion with a curable matrix material, a fiber arrangement is conventionally applied to a horizontally oriented support surface, which can be designed, for example, as a support table. A liquid matrix material is usually applied from above onto the fiber arrangement applied to such a support surface, in order to intersperse the fiber arrangement with the liquid matrix material with the help of gravity and capillary effects.

Such an interspersion of a fiber arrangement with a liquid matrix material usually results in a part of the matrix material which intersperses the fiber arrangement coming into direct contact with the support surface, whereby the support surface is contaminated, in particular with a sticky resin component of the liquid matrix material. This problem applies in particular to large components or multi-layered components. Alternatively, a preimpregnated fiber arrangement may be used as a type of prepreg, which can likewise lead to contamination.

For this reason, one is conventionally compelled to arrange a protective layer between a support surface and a fiber arrangement resting on the support surface. The protective layer prevents direct contact between a liquid matrix material interspersing a fiber arrangement and the support surface, thus protecting the support surface from contamination with the liquid matrix material. A conventional protective layer is formed in web form from paper or plastic film.

The protective layer may be placed on the support surface with or without the formation of a cohesive connection, in particular an adhesion, with the support surface. Subsequently, a fiber arrangement can be applied to the protective layer and interspersed with a liquid matrix material. The fiber arrangement may also already be pre-impregnated. After removal of the interspersed fiber arrangement from the protective layer and the support table, the protective layer which has been contaminated with the matrix material must also be removed from the support surface, so that a clean protective layer for a further fiber arrangement can be applied to the support surface.

Mechanical grippers are conventionally used for supplying a fiber arrangement which has been interspersed with a curable matrix material to a pressing tool. These grippers engage edge portions of the fiber arrangement. In order not to contaminate the grippers with the matrix material, the edge portions of the fiber arrangement are usually not provided with the matrix material. The edge portions of the fiber arrangement which are not provided or interspersed with the matrix material are removed from the section of the fiber arrangement interspersed with matrix material after the production of a component by wet pressing and disposed of as waste.

The object of the invention is to provide a method and corresponding device for the simple and inexpensive production of components made from fiber arrangements interspersed with curable matrix material.

This and other objects are achieved by a method and device for handling a fiber arrangement to be supplied to a pressing tool. The fiber arrangement is interspersed with a curable matrix material at least in some sections before being supplied to the pressing tool and then is supplied to the pressing tool. The fiber arrangement is supplied to the pressing tool largely without contact by way of acoustic levitation after being interspersed with the matrix material.

In the method according to an embodiment of the invention, the fiber arrangement is supplied to the pressing tool largely without contact by acoustic levitation. This avoids the fiber arrangement interspersed with curable matrix material from coming into close contact with the support surface and heavily contaminating said support surface. Particularly preferably, the supply takes place completely without contact, wherein at least the support surface is not contaminated with the matrix material. Here a type of prepegs may be used directly before the supplying of fiber arrangements interspersed with matrix material or pre-impregnated fiber arrangements.

The contactless handling of the fiber arrangement by the method may include the fixed holding of the fiber arrangement. It may further include a movement of the fiber arrangement. Such movements may serve, for example, to supply the fiber arrangement to a device for interspersing the fiber arrangement at least in some sections with a liquid matrix material before it is supplied to a pressing tool.

In a method of the aforementioned type, the fiber arrangement is preferably handled without contact by way of acoustic levitation during its interspersion with the liquid matrix material.

Through the contactless handling of the fiber arrangement by way of acoustic levitation during its interspersion with the liquid matrix material, the liquid matrix material is prevented from coming into direct contact with a component of a device for handling the fiber arrangement and contaminating this component. The conventional arrangement of a protective layer between the fiber arrangement and components of the device for handling the fiber arrangement, in particular a support surface, is hereby unnecessary. Consequently, the costs of acquisition and disposal of conventional protective layers are dispensed with in the method according to the invention. In addition, no handling of a conventional protective layer must be carried out in the method according to the invention. As a result, the technical effort for the automated handling of such a protective layer can be dispensed with, which is also accompanied by a reduction of production costs with respect to a component produced from a fiber arrangement interspersed with a liquid matrix material.

Furthermore, no additional edge sections must be provided at an edge of a fiber arrangement, which additional edge sections are not provided with a liquid matrix material and against which mechanical grippers for handling the fiber arrangement may engage. This is because the handling of the fiber arrangement may occur without contact and without the use of mechanical or other grippers. Consequently, the fiber arrangements can be produced without the conventional edge sections, which provides a reduction in material costs and thus with an overall reduction in costs. In addition, no edge sections need to be removed from the remaining fiber arrangement and disposed of as waste after wet pressing, which is likewise accompanied by a reduction of costs.

It has been shown that the interspersion of a fiber arrangement with a liquid matrix material is supported by the effect of sound waves, which cause acoustic levitation, on the fiber arrangement and the liquid matrix material arranged thereon. This can improve the achievable interspersion results, in particular with respect to a homogeneous interspersion.

In addition, an interspersion according to the method can occur more quickly and thus cost-effectively than usual, as a liquid matrix material with a lower viscosity can be used than is the case in the conventional method. The viscosity of the liquid matrix material used in conventional methods is to be selected to be as low as possible, while preventing, as far as possible, the liquid matrix material from flowing through the fiber arrangement onto a support surface and contaminating said support surface. The higher the viscosity of a liquid matrix material, however, the longer it takes to achieve the desired interspersion result.

Within the scope of the invention, the fiber arrangement may be a fiber fabric, fiber woven fabric or the like.

According to a further advantageous embodiment, the acoustic levitation is used to form a near-field levitation. Here, an air cushion is built up between a sound wave generating unit and the fiber arrangement, which keeps the fiber arrangement at a distance from this unit. This configuration is particularly useful when the sound wave generating unit is below the fiber arrangement during handling of the fiber arrangement.

The sound waves used for levitation are preferably ultrasonic waves. The frequency of the ultrasonic waves is to be selected depending on the properties of the fiber arrangement to be contactlessly handled.

A further advantageous embodiment provides that the fiber arrangement is acted upon by sound waves from one of its two large sides during its interspersion with liquid matrix material, while the liquid matrix material is applied to the fiber arrangement from the respectively opposite large side. As a result, a sound wave field arranged between the fiber arrangement and a unit for the generation of levitation sound waves is not affected by the application of the liquid matrix material.

According to the invention, a device of the aforementioned type is proposed which includes a handling apparatus designed to supply the fiber arrangement which has been interspersed with curable matrix material to the pressing tool with as little contact as possible by way of acoustic levitation. A contamination of the handling apparatus with matrix material is thereby advantageously reduced, and preferably completely avoided. Here, the handling apparatus may supply preimpregnated fiber arrangements to the pressing tool or fiber arrangements which have been interspersed with matrix material within the handling apparatus.

The handling apparatus of the aforementioned type is preferably designed to hold the fiber arrangement largely without contact by way of acoustic levitation, at least during its interspersion with the liquid matrix material.

The advantages mentioned above with reference to the method are correspondingly connected to this device.

In an advantageous embodiment, the handling apparatus is designed to supply the fiber arrangement interspersed with liquid matrix material to the pressing tool without contact by way of acoustic levitation. The advantages associated with the corresponding embodiment of the method are also applicable here.

It is further considered advantageous if the handling device has at least one sonotrode connected to a vibrating apparatus, with which near-field levitation sound waves can be generated.

According to the invention, a use of the aforementioned device is proposed in which the device is designed according to one of the aforementioned embodiments, or any combination thereof. The advantages mentioned above with respect to the device and method are thus also applicable to the use.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a highly schematic representation of an embodiment for a device according to the invention.

### DETAILED DESCRIPTION OF THE DRAWING

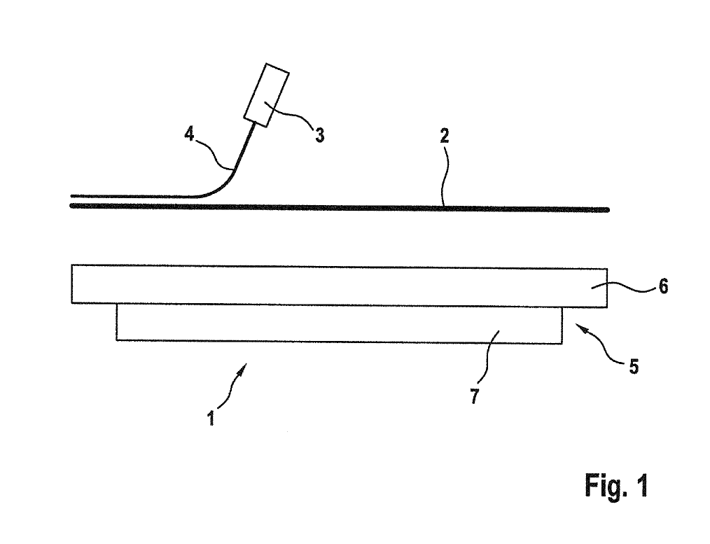

FIG. 1 is a highly schematic representation of an embodiment of a device 1 according to the invention for handling a fiber arrangement 2 to be supplied to a pressing tool (not shown).

The device 1 includes an apparatus 3 for interspersing the fiber arrangement 2 at least in some sections with a liquid matrix material 4 before the fiber arrangement is supplied to the pressing tool, whereby only the application nozzle of the apparatus 3 is shown. The device 1 further includes a handling apparatus 5 for holding the fiber arrangement 2 during interspersion with the liquid matrix material 4 and for supplying the fiber arrangement 2, which has been interspersed with the liquid matrix material 4, to the pressing tool.

The handling apparatus 5 is designed to hold the fiber arrangement 2 without contact by way of acoustic levitation at least during its interspersion with the liquid matrix material 4 and to supply the fiber arrangement 2 interspersed with liquid matrix material 2 without contact to the pressing tool by way of the acoustic levitation. The handling apparatus 5 includes a sonotrode 6, with which near-field levitation sound waves can be generated. For this purpose, the sonotrode 6 is connected to a vibrating apparatus 7, which can be electronically controlled.

The acoustic levitation which can be produced by way of the handling apparatus 5 is used to create a near-field levitation, wherein an air cushion, not shown in detail, is formed between the fiber arrangement 2 and the sonotrode 6. The air cushion maintains a distance between the fiber arrangement 2 and the sonotrode 6.

### LIST OF REFERENCE CHARACTERS

1 device
2 fiber arrangement
3 apparatus
4 liquid matrix material
5 handling apparatus
6 sonotrode
7 vibrating apparatus

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for handling a fiber arrangement to be supplied to a pressing tool, wherein the fiber arrangement is interspersed with a curable matrix material, at least in sections, before being supplied to the pressing tool, the method comprising the acts of:
acoustically levitating the fiber arrangement to be supplied to the pressing tool; and
supplying the fiber arrangement to the pressing tool largely without contact via the acoustic levitation after the fiber arrangement is interspersed with the curable matrix material.

2. The method according to claim 1, wherein, during the interspersion of the fiber arrangement with the curable matrix material, the fiber arrangement is handled largely without contact via the acoustic levitation.

3. The method according to claim 1, wherein the acoustic levitation creates a near-field levitation.

4. The method according to claim 2, wherein the acoustic levitation creates a near-field levitation.

5. The method according to claim 1, further comprising the acts of:
during the interspersion of the fiber arrangement with the curable matrix material, acting upon one of the two large sides of the fiber arrangement via sound waves of the acoustic levitation; and
applying the curable matrix material to an opposite one of the two large sides of the fiber arrangement.

6. The method according to claim 4, further comprising the acts of:
during the interspersion of the fiber arrangement with the curable matrix material, acting upon one of the two large sides of the fiber arrangement via sound waves of the acoustic levitation; and
applying the curable matrix material to an opposite one of the two large sides of the fiber arrangement.

7. A device for handling a fiber arrangement to be supplied to a pressing tool, the device comprising:
a handling apparatus configured to supply the fiber arrangement that has been interspersed with a curable matrix material to the pressing tool, wherein
the handling apparatus is configured to use acoustic levitation in order to supply the fiber arrangement interspersed with the curable matrix material to the pressing tool largely without contact.

8. The device according to claim 7, further comprising:
an interspersing apparatus configured to intersperse the fiber arrangement, at least in sections, with a liquid curable matrix material before the fiber arrangement is supplied to the pressing tool, wherein
the handling apparatus is configured to hold the fiber arrangement during interspersing of the fiber arrangement with the liquid curable matrix material.

9. The device according to claim 8, wherein the handling apparatus is configured to hold the fiber arrangement largely without contact via the acoustic levitation at least during the interspersing of the fiber arrangement with the liquid curable matrix material.

10. The device according to claim 7, wherein the handling apparatus comprises a sonotrode and a vibrating apparatus operatively coupled together, the sonotrode being operable to generate near-field sound waves.

11. The device according to claim 8, wherein the handling apparatus comprises a sonotrode and a vibrating apparatus operatively coupled together, the sonotrode being operable to generate near-field sound waves.

12. The device according to claim 9, wherein the handling apparatus comprises a sonotrode and a vibrating apparatus operatively coupled together, the sonotrode being operable to generate near-field sound waves.

13. The device according to claim 7, wherein the device is used for handling the fiber arrangement to be supplied to the pressing tool, the fiber arrangement having being interspersed at least in sections with the curable matrix material.

14. The device according to claim 13, wherein the device is used for handling the fiber arrangement during the interspersion of the fiber arrangement with the curable matrix material.
